(19) United States
(12) Patent Application Publication
(10) Pub. No.: US 2008/0133089 A1
(43) Pub. Date: Jun. 5, 2008

(54) Height-Adjusting Wheelchair

(76) Inventors: Ahmad Bayomy, Pullman, WA (US); Nick Rapagnani, University Place, WA (US); Sepideh Zolfaghari, Tacoma, WA (US)

Correspondence Address: David A. Divine;Lee & Hayes, PLLC, Suite 500, 421 W. Riverside Avenue, Spokane, WA, 99201, US

(21) Appl. No.: 11/565,493

(22) Filed: Nov. 30, 2006

(51) Int. Cl. A61G 5/10; G06F 17/00; B60N 2/16

(52) U.S. Cl. 701/49; 280/250.1; 297/217.3

(57) ABSTRACT

Height-adjusting wheelchairs allow an occupant of the wheelchair to adjust the height of the wheelchair seat above the ground. A height-adjusting manually propelled wheelchair may include a base frame supported by two rear wheels, and a vertically movable seat assembly is positioned above the base frame. A height adjustment system adjusts the height of the seat assembly relative to the base frame.

### BACKGROUND

Millions of people live with mobility-related disabilities that require the use of a wheelchair, walker, or other mobility equipment. Individuals with mobility limitations face a myriad of physical and psychological challenges associated with daily wheelchair use. For example, the simple tasks of reaching objects in overhead cupboards, viewing performances, and getting in or out of a car, present real physical challenges for many people with mobility-related disabilities. Many of these individuals are unable to participate in activities due to their disabilities, or risk injury by attempting the activities without adequate equipment.

In addition to these physical challenges, wheelchair users also suffer from social and psychological challenges associated with wheelchair use. For example, wheelchair users typically are at a lower vantage point than their standing peers. This lower vantage point means that wheelchair users are, quite literally, looked down upon in many social situations. This lower vantage point may create a real or perceived disadvantage in many social situations. These physical and sociological challenges may lead wheelchair users to feel helpless or frustrated by their limitations.

Existing wheelchairs and other mobility equipment do not adequately address the various physical and psychological challenges faced by those with mobility-related disabilities.

### SUMMARY

This summary is provided to introduce simplified concepts of height-adjusting wheelchairs, which are further described below in the Detailed Description. This summary is not intended to identify essential features of the claimed subject matter, nor is it intended for use in determining the scope of the claimed subject matter.

This disclosure is directed to height-adjusting wheelchairs, which allow an occupant of the wheelchair to adjust the height of the wheelchair seat above the ground. In some implementations, wheelchairs include a base frame coupled to and supported by three or more wheels. A seat assembly is positioned above and coupled to the base frame exclusively by a lifting mechanism for adjusting a height of the seat assembly relative to the base frame. The lifting mechanism includes multiple lift cylinders, each coupled to the base frame and the seat assembly. A pump is in fluid communication with the lift cylinders to selectively extend and retract the cylinders.

In other implementations, height-adjusting manually propelled wheelchairs include a base frame supported by two rear wheels configured to be manually driven by a user and at least one front caster wheel. A vertically movable seat assembly is positioned above the base frame. A height adjustment system couples the seat assembly to the base frame for vertical movement relative to the base frame.

In still other implementations, manually propelled height-adjusting wheelchairs include a hydraulic height adjustment mechanism, and weigh at most about thirty-seven pounds.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a front perspective view of an exemplary height-adjusting manual wheelchair according to one implementation in a lowered position.

FIG. 2 is a rear perspective view of the height-adjusting manual wheelchair of FIG. 1 in a lowered position.

FIG. 3 is a front perspective view of the height-adjusting manual wheelchair of FIG. 1 in an elevated position.

FIG. 4 is a rear perspective view of the height-adjusting manual wheelchair of FIG. 1 in an elevated position.

FIG. 5 is an exploded view of the height-adjusting manual wheelchair of FIG. 1, showing individual parts and subassemblies of the wheelchair.

FIG. 6 is a front perspective view of an exemplary height-adjusting manual wheelchair according to another implementation in a raised position.

### DETAILED DESCRIPTION

### Overview

This disclosure is directed to height-adjusting wheelchairs, which allow an occupant of the wheelchair to adjust the height of the wheelchair seat and, consequently, the occupant's height above the ground. By virtue of the adjustable height, wheelchairs according to this disclosure may help offset physical limitations associated with wheelchair use. For example, some height-adjusting wheelchair implementations may allow a user to reach elevated cabinets, appliances, and other fixtures. The user may also be able to adjust his or her viewing level to provide optimal visibility at performances, sporting events, or other social activities. Social stigmas associated with engaging in conversation at a reduced height may also be reduced or eliminated.

The increased ability to use household fixtures, see at events, and more easily engage in conversation may also have a positive physical impact on the user by alleviating neck strain associated with tilting the head and/or shoulder strain associated with users propping themselves up to a higher viewing level using their armrests. In addition, the height-adjusting wheelchair may open more vocational opportunities to users with mobility disabilities.

### Exemplary Height-Adjusting Wheelchair

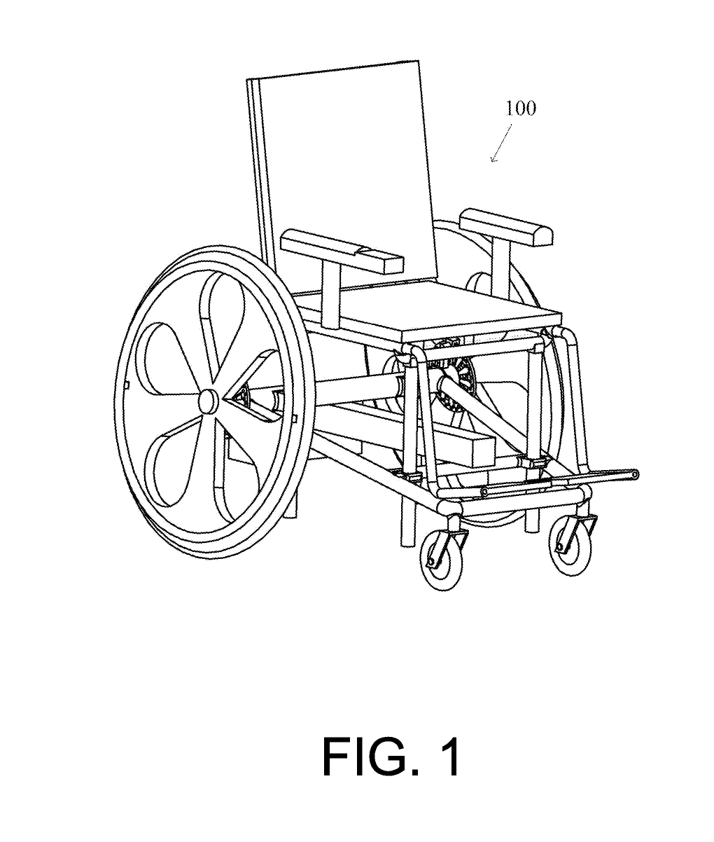

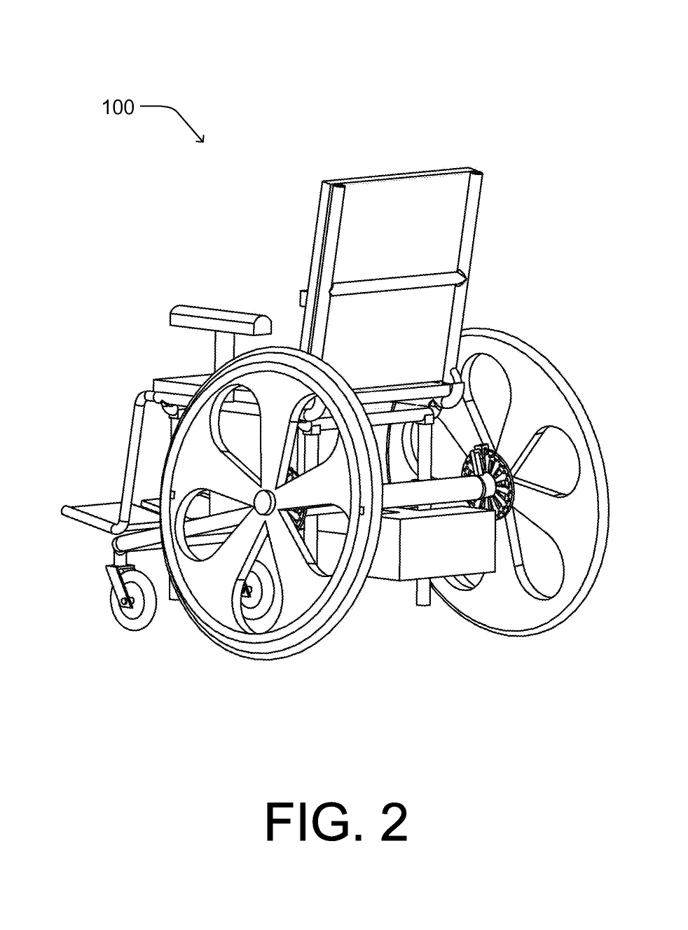

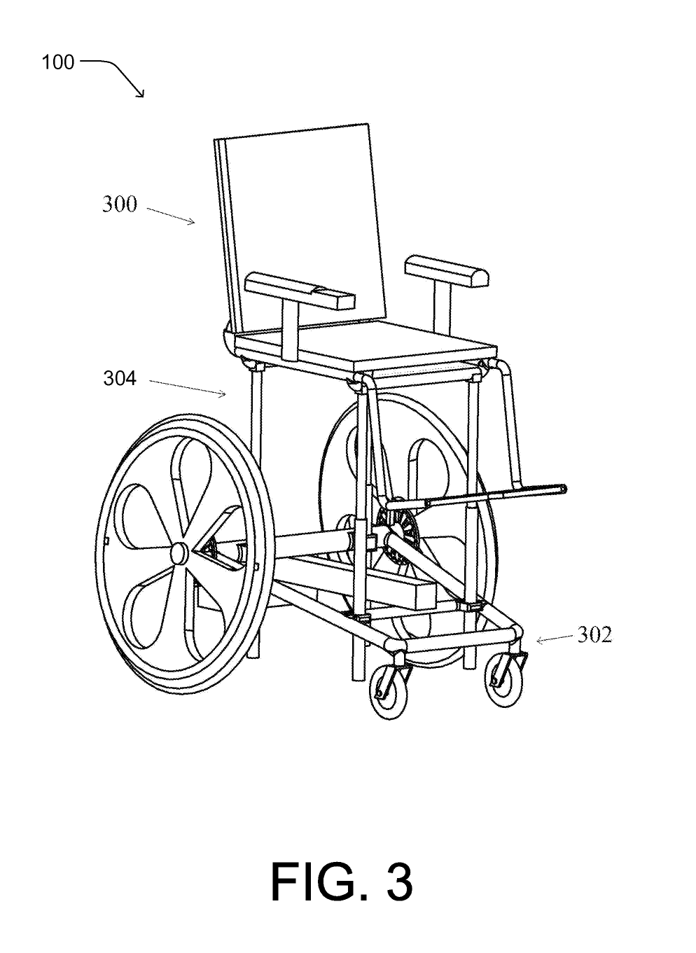

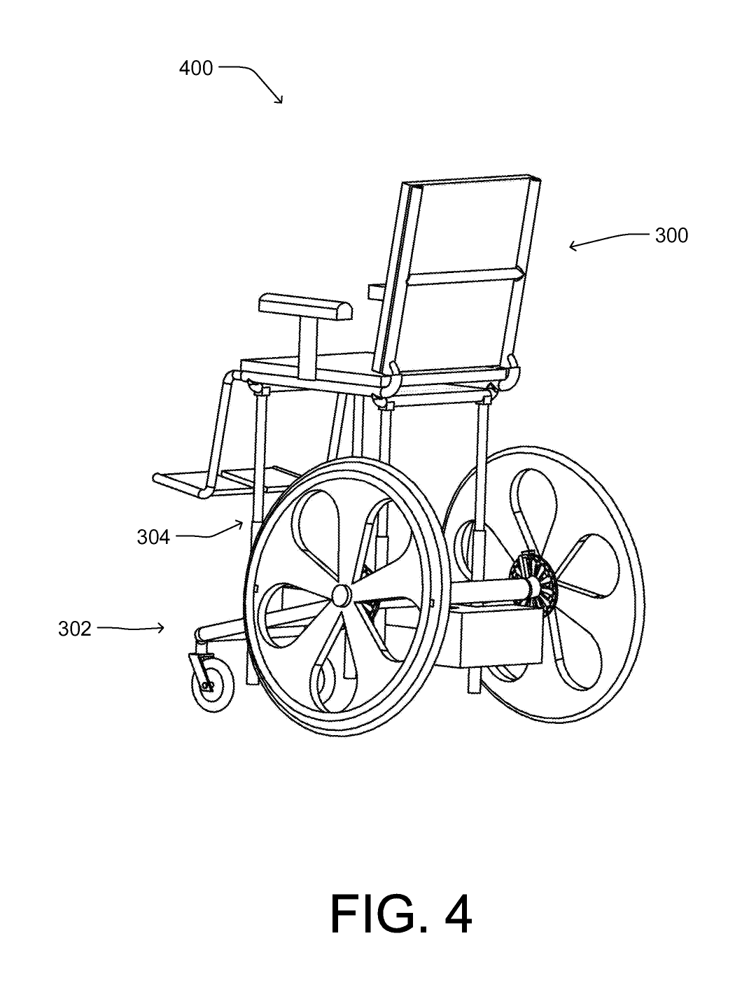

FIGS. 1-4 illustrate an exemplary height-adjusting wheelchair 100, which is adjustable between a lowered condition (shown in FIGS. 1 and 2) and an elevated condition (shown in FIGS. 3 and 4). In this implementation, the height-adjusting wheelchair is a manually propelled (or “manual”) wheelchair, in which the occupant provides the primary means of propelling the wheelchair. Accordingly, the height-adjusting wheelchair 100 is designed to be relatively light-weight for ease of use and transport. However, in other implementations, the height-adjusting features described herein may also be applied to electrically-propelled or motorized wheelchairs, transport chairs, heavy-duty chairs, or the like, in which case heavier chairs may also be used.

As shown in FIG. 3, the height-adjusting wheelchair 100 generally comprises a seat assembly 300 coupled to a wheeled chassis 302 by a lifting mechanism 304, such that the seat assembly 300 can be raised and lowered relative to the chassis 302, while maintaining a substantially constant seating angle relative to the ground. In the illustrated implementation, the lifting mechanism 304 is the only structure coupling the seat assembly 300 to the chassis 302. That is, the lifting mechanism 304 provides all of the vertical, lateral, longitudinal, and torsional support for the seat assembly 300; no additional guide members or supports are necessary. This design results in a substantial weight reduction over other chair designs which use various support or guide members to provide stability.

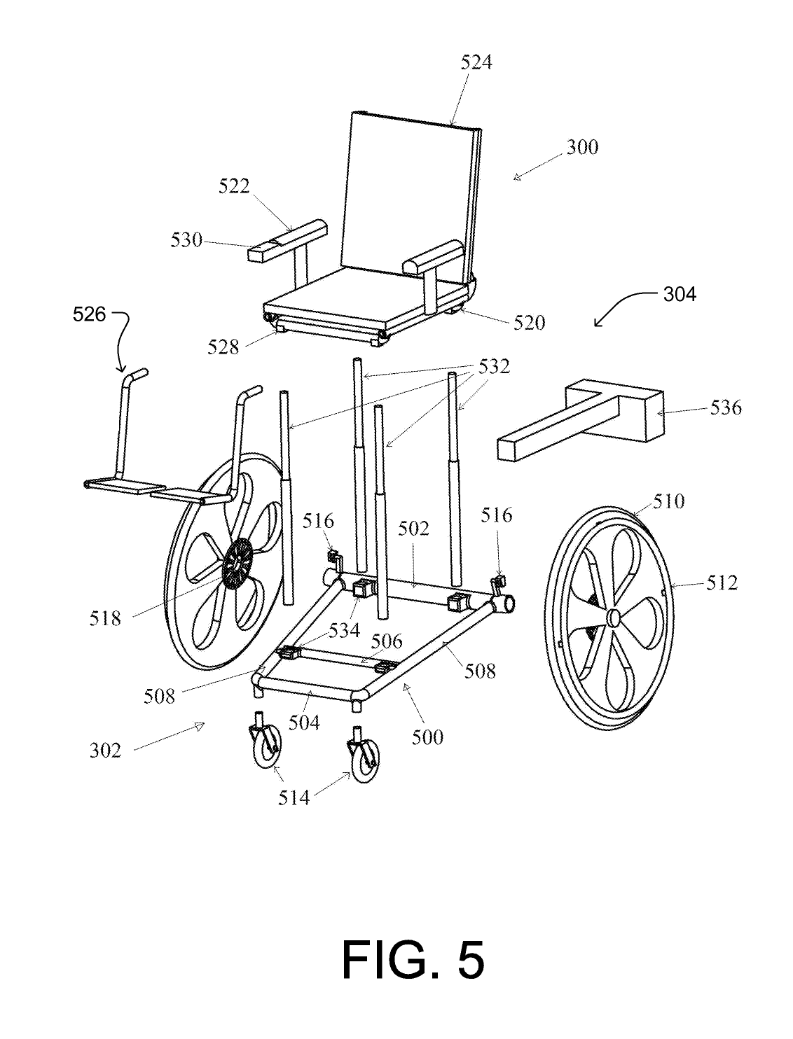

FIG. 5 is an exploded view showing components of the height-adjusting wheelchair 100 in more detail. The chassis 302 comprises a base frame 500 including a rear axel 502, a frontal support 504, a mid cross support 506, and two side frame members 508. Two large rear wheels 510 are coupled to the rear axel 502 and include hand rims 512, which can be grasped by a user to propel the wheelchair 100. Two front casters 514 are coupled to the frontal support 504 and allow the wheelchair 100 to rotate freely. The side frame members 508 are canted slightly inward toward the front, such that the casters 514 are located closer together than the rear wheels 510. The narrower arrangement of the front casters 514 facilitates ingress and egress to and from the wheelchair 100, and provides better maneuverability and clearance. Also, the front casters 514 may be mounted somewhat lower to the ground than the rear axel 502. Thus, a plane defined by the rear axel and the caster mounts tilts downward toward the front of the wheelchair 100. This may further ease ingress and egress to and from the wheelchair 100. The chassis 302 may also include anti-tip bars (not shown) to provide further stability to the wheelchair 100.

One or more of the wheels may include a brake to apply a braking force to stop the wheelchair. In the implementation shown, the wheelchair 100 includes disk brake calipers 516 that engage rotors 518 coupled to the hubs of the two rear wheels 512 (the mounted configuration is best shown in FIGS. 2 and 4). Details of the disk brake actuators are not shown; however, the disk brakes may be manually actuated using mechanical linkage (e.g., pull cables, levers, or the like) or may include power assisted braking (e.g., using hydraulic pressure, electric motors, or the like). In one implementation, the disk brakes are E-Brake Disc Brakes made by Accessible Designs, Inc. (ADI), of San Antonio, Tex., which utilize a 12 volt direct current (DC) motor to provide the braking force. In some implementations, the brakes may be driven and powered by the motor and power supply of the lifting mechanism. In addition to or instead of disk brakes, other types of conventional braking mechanisms could also be used, such a caliper brakes, drum brakes, locking levers, and the like.

The seat assembly 300 is mounted above the chassis 302 and includes a seat bottom frame 520, arm rests 522, and a reclining seatback 524. The seat assembly 300 may also include footrests 526 and seat and back cushions (not shown). The seat bottom frame 520 includes one or more mounts 528 configured for engagement with the lifting mechanism 304.

In some implementations, controls 530 for the lifting mechanism 304 and/or the brakes may be mounted in one or both arm rests 522 of the seat assembly. Controls for the lifting mechanism and the brakes may be manual or electronic, and may be integrated in one controller or provided separately. In addition, in some implementations, the controls 530 may be configured as a wired or wireless remote control that can be detached from the armrest. In one implementation, the controls comprise a wireless infrared or radio frequency remote control. Numerous other control arrangements are also possible.

The lifting mechanism 304 comprises four lifting cylinders 532 interposed between and coupling the seat assembly 300 to the chassis 302, such that the seat assembly 300 is movable substantially vertically relative to the chassis 302 while maintaining substantially the same angle of the seat relative to the ground. In the illustrated implementation, the four lifting cylinders are coupled to the base frame 500 at mounts 534 and to the seat assembly 300 at mounts 528 in a substantially vertical arrangement. However, in other implementations, the cylinders 532 could be coupled to the base frame 500 and/or the seat assembly 300 at some angle offset from vertical. For example, the cylinders could be angled forward such that lifting motion of the seat assembly includes both a vertical and a forward component of motion, relative to the wheelchair.

The mounts 528 and 534 may be coupled to the seat assembly 300 and base frame 500, respectively, by welding or any other suitable attachment means. The mounts 528 and/or 534 provide cantilevered supports that substantially prevent the cylinders 532 from pivoting relative to the seat assembly 300 and/or the chassis 302. The cylinders 532 are designed to withstand transverse loads as well as vertical loads. Thus, no additional guides or supports are necessary to stabilize the seat assembly 300 relative to the chassis 302. Accordingly, in this implementation, the cylinders 532 are the only structure connecting the seat assembly 300 to the chassis 302, thereby minimizing the weight of the height-adjusting wheelchair 100.

The travel of the lifting cylinders 532 may be chosen to accommodate the desired lifting height. In various implementations, the lifting cylinders may have a travel of between about six inches and about twenty-four inches. Typically, however, the lifting cylinders 532 should have about eight inches to about eighteen inches of travel, to provide adequate seat height adjustments while maintaining stability of the wheelchair 100.

The lifting cylinders 532 may be hydraulically or pneumatically driven by a hydraulic or pneumatic pump box 536, depending on various design considerations, such as cost, weight, load requirements, noise, and the like. In one implementation, the cylinders 532 comprise hydraulic gas springs driven by a hydraulic pump box 536. The hydraulic pump box 536 includes a hydraulic pump and an electric motor for driving the pump. Each of the cylinders 532 is in fluid communication with the pump box 536 by hydraulic hoses (not shown). Via the hydraulic hoses, the pump box 536 pressurizes all of the cylinders 532 synchronously. One exemplary gas spring hydraulic system (cylinders, pump, and motor) that may be used is the Easymotion linear actuation system, available from Bansbach easylift GmbH of Lorch, Germany. In other implementations, the hydraulic pump and electric motor may be provide separately, rather than as an integral pump box. By using a hydraulic or pneumatic lifting system, only minimal application or release of force (e.g., pressing a button or lever) is required from the user to lift or lower the seat assembly.

Nevertheless, in some alternative implementations, the cylinders 532 may be manually extended and retracted using a mechanical user input (e.g., a hand crank, lever, or the like) to drive the hydraulic pump. In yet another alternative, a hand crank, lever, or other manual user input may be provided as a backup or failsafe, to allow the seat assembly to be raised or lowered in the event that the electric motor malfunctions or the battery is discharged.

In the implementation shown in FIG. 5, a fluid reservoir end of each of the cylinders 532 is attached to the chassis 302, while an extending piston end is attached to the seat assembly 300. In that case, the pump box 536 is typically mounted to the chassis 302 of the chair to minimize the length of the hydraulic hoses and limit the flexing of the hoses. Similarly, if the cylinders are mounted in the opposite direction with the fluid reservoir end of each of the cylinders 532 attached to the seat assembly 300 and the piston end attached to the chassis 302, the pump box 536 may be mounted to the seat assembly 300. Of course, the pump box 536 and cylinders 532 may be mounted to the seat assembly 300 and chassis 302 in various other implementations as well.

A power supply (not shown), such a battery, fuel cell, or the like, is provided in electrical communication with the electric motor to supply power to the electric motor. In some implementations, the power supply may also provide power to the brakes and/or the controller 530. The power supply may be integral with or separate from the pump box. Additionally or alternatively, the power supply may be integrated in a portion of the seat assembly 300 or the chassis 302. In one implementation, the power supply may comprise a rechargeable DC battery. In that case, the rechargeable batter should, but need not necessarily, have enough ampere-hours to provide twenty hours of use or more.

The pump box (or pump and electric motor if separate components are used) and/or power supply may be positioned in any desired location. In one implementation, these components are located in a central portion of the chassis 302 relatively low to the ground for weight distribution purposes and to lower the center of gravity of the wheelchair 100.

The height-adjusting wheelchairs described herein are designed for everyday use. Accordingly, the height-adjusting wheelchairs should, but need not necessarily, be relatively light weight, transportable, and easy to use. In many implementations, manual height-adjusting wheelchairs described herein weigh less than about forty pounds, and generally weigh less than about thirty-seven pounds. In some cases, manual height-adjusting wheelchairs described herein may weigh even less than thirty-two pounds. These relatively light weights are achieved by eliminating the need for any support or guide structures other than the lifting mechanism (see e.g., FIG. 3), and by manufacturing the wheelchair from high strength-to-weight ratio materials, such as aluminum, titanium, and alloys thereof, carbon fiber, certain lightweight polymeric materials, and the like. Of course, virtually any material or combination of materials having a relatively high strength-to-weight ratio may be used.

In one implementation, the majority of the seat assembly and chassis frame members are constructed of 6061-T6 aluminum alloy. Ti-6AL-4V titanium alloy is used for the axle and the frontal cross beam, which support the lifting cylinders, for durability under cyclic loading. In another alternative, some or the entire frame could be made of Aluminum 7005 alloy.

In some implementations (e.g., oversized or heavy-duty wheelchairs, motorized wheelchairs, transport chairs, and the like), higher weights may be acceptable. In that case, heavier materials, such as steel, stainless steel, and plastics may additionally or alternatively be used.

The manual height-adjusting wheelchairs described herein may be collapsible in whole or in part. In one implementation, manual height-adjusting wheelchairs described herein are partially collapsible, including removable wheels (via quick release axles), a collapsible seatback, and removable or collapsible arm and leg rests.

For ease of use, in some implementations, manual height-adjusting wheelchairs should be at most about thirty-four inches wide and about fifty inches long. In one implementation, a manual height-adjusting wheelchair is about thirty-two inches wide and about forty inches long. However, in some implementations, height-adjusting wheelchairs may exceed these dimensions to provide a larger wheelbase, to support heavier loads, or for a variety of other reasons.

### Alternative Exemplary Height-Adjusting Wheelchair

While a total of four wheels are used on the height-adjusting wheelchair 100 shown in FIGS. 1-5, in other implementations, any number of three or more wheels may be used to increase maneuverability, to reduce weight, or for any other desired reason. Also, as noted above, any number of two or more lifting cylinders may be used.

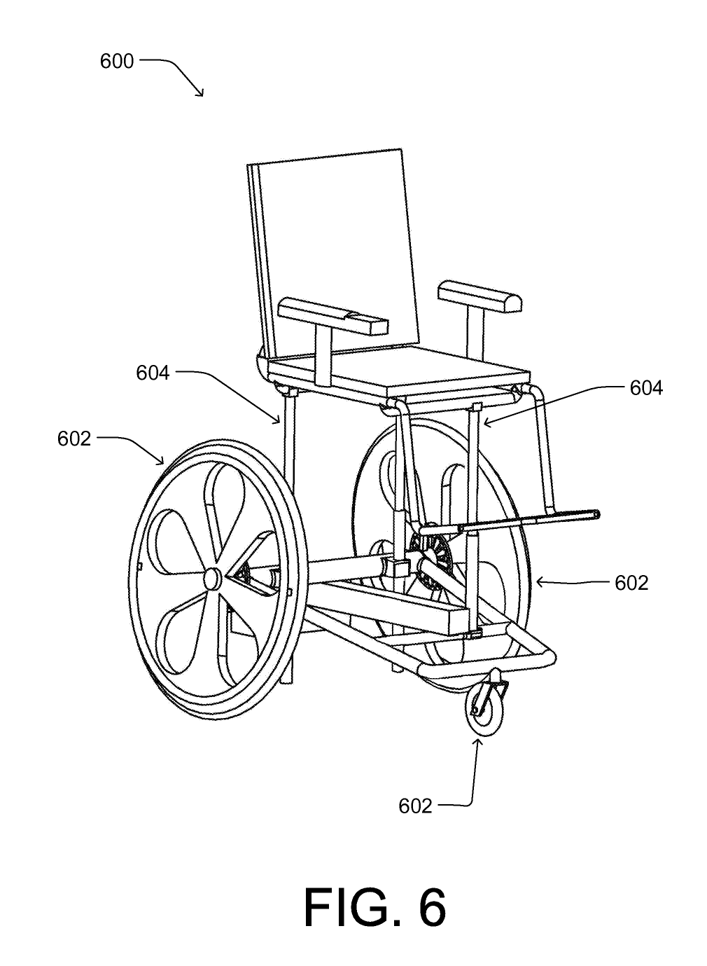

FIG. 6 illustrates an exemplary height-adjusting wheelchair 600, having only three wheels 602 and three lifting cylinders 604. In all other respects, the wheelchair 600 is identical to that shown in FIGS. 1-5. Accordingly, a detailed description of wheelchair 600 has been omitted for brevity.

It should be understood that other chair designs may also be used, including chairs having any combination of three or four wheels and two, three, or four lifting cylinders. In addition, chair designs having even more wheels and/or lifting cylinders may be desirable in some cases.

### Height-Adjusting Operation and Control

In operation, a user of a height-adjusting wheelchair, such as those shown in FIGS. 1-6, can adjust the seat height of the wheelchair using a controller mounted on an armrest or elsewhere on the chair. The controller may be implemented using an integrated circuit, or using a processor with programmable memory. The controller may include a display indicating a present height of the seating assembly above the ground and/or relative to the lowered position, a remaining charge available in the power supply, or any other information that would be useful for the user of the wheelchair. In one implementation, the controller is the control system provided with the Easymotion linear actuation system, available from Bansbach easylift GmbH of Lorch, Germany.

As mentioned above, the controller may be detachable and may be in wired or wireless communication with the lifting mechanism. Using the controller, the user can raise or lower the entire seat assembly. The elevating motion translates into the user being raised vertically with respect to the ground, increasing their eye level viewing plane, vertical reaching ability, and overall height from the ground. During this lifting motion, the user's seating angle remains substantially constant. That is, the seat surface is not significantly tilted during lifting or lowering of the seating assembly. In some instances, the lifting motion may include both a vertical and a forward component, with respect to the wheelchair. To effect a height increase, the controller instructs the electric motor to displace fluid within the hydraulic pump. The fluid enters the reservoirs of the lifting cylinders, performing work on the lifting cylinder pistons to extend the pistons and raise the seating assembly. Both the elevation and descent motions are controlled by the powered system. Thus, no application or release of force is required from the user for either lifting or lowering motion to be executed.

The motion can be stopped at any desired point along the accent or decent at the user's discretion. The controller may be adjustable to raise and lower the seat assembly between a plurality of discrete height positions (e.g., any number of two or more discrete positions), or may be continuously and variably adjustable to any position between a fully raised position and a fully lowered position.

In some implementations, one or more sensors may be provided on the wheelchair. For example, a height-adjusting wheelchair may include a gradient sensor in communication with the controller for determining a gradient of a surface on which the wheelchair is supported. In one implementation, the gradient sensor comprises an accelerometer capable of detecting static (or gravitational) acceleration, such as the ADXL202, manufactured by Analog Devices, Inc. of Norwood, Mass. Other sensors that may be present include one or more speed sensors, accelerometers, seat elevation sensors, user weight sensors, and the like. The gradient sensor and/or other sensors may be incorporated in the controller, or may be located elsewhere on the wheelchair and in communication with the controller.

The controller may also include various safety functions. For example, the controller may be configured to limit or inhibit elevation of the upper frame if the gradient sensor detects a predetermined potentially unsafe gradient. The predetermined gradient may depend on various factors, such as user weight, location of center of gravity, wheelbase of chair, and the like. The gradient may be set at the factory and/or may be adjustable by a user or technician in the field.

In another example safety feature, the controller may be configured to lock the brake when the seat assembly is in an elevated position. This will prevent any wheel movement by the user or other forces.

### CONCLUSION

Although the invention has been described in language specific to structural features and/or methodological acts, it is to be understood that the invention is not necessarily limited to the specific features or acts described. Rather, the specific features and acts are disclosed as exemplary forms of implementing the invention.

What is claimed is:

1. A wheelchair comprising:
a base frame coupled to and supported by three or more wheels;
a seat assembly positioned above and coupled to the base frame exclusively by a lifting mechanism for adjusting a height of the seat assembly relative to the base frame, the lifting mechanism comprising:
two or more lift cylinders, each coupled to the base frame and the seat assembly; and
a pump in fluid communication with the lift cylinders to selectively extend and retract the cylinders.

2. The wheelchair of claim 1, wherein the wheelchair is a manually propelled wheelchair.

3. The wheelchair of claim 1, wherein the seat assembly comprises an upper frame, by which the lift cylinders are coupled to the upper frame of the seat assembly.

4. The wheelchair of claim 1, wherein the lifting mechanism is configured such that both lifting and lowering of the seat assembly are performed under power.

5. The wheelchair of claim 1, wherein the lift cylinders are disposed substantially vertically and are configured for extension and compression in a substantially vertical direction, such that when adjusting the height of the seat assembly, the seat assembly remains at substantially the same angle relative to the ground.

6. The wheelchair of claim 1, wherein the lift cylinders comprise hydraulically actuated gas springs.

7. The wheelchair of claim 1, further comprising a controller for controlling height adjustment of the seat assembly.

8. The wheelchair of claim 7, further comprising a gradient sensor in communication with the controller, the gradient sensor for determining a gradient of a surface on which the wheelchair is supported.

9. The wheelchair of claim 8, wherein the controller limits elevation of the seat assembly if the gradient sensor determines that the wheelchair is on a predetermined unsafe gradient.

10. The wheelchair of claim 7, further comprising a brake for braking one or more of the wheels, wherein the controller is configured to lock the brake when the seat assembly is in an elevated position.

11. The wheelchair of claim 7, wherein the controller is detachably coupled to an armrest of the seat assembly.

12. The wheelchair of claim 7, wherein the controller is in wireless communication with the lifting mechanism.

13. The wheelchair of claim 1, wherein the wheelchair weights at most about 37 pounds (17 kilograms).

14. The wheelchair of claim 1, wherein the lift cylinders have sufficient travel to facilitate vertical adjustment of the seat assembly by at least about 8 inches (20 centimeters).

15. The wheelchair of claim 1, the base frame comprising a rear axle, extending between two rear wheels, and two front caster mounts for mounting two front caster wheels, and wherein a plane defined by the rear axel and the front caster mounts tilts downward toward the front of the wheelchair.

16. The wheelchair of claim 1, further comprising an electric motor coupled to the pump to drive the pump, and a power supply to power the electric motor.

17. A height-adjusting manually propelled wheelchair comprising:
a base frame supported by two rear wheels configured to be manually driven by a user and at least one front caster wheel;
a vertically movable seat assembly disposed above the base frame; and
a height adjustment system coupling the seat assembly to the base frame for vertical movement relative to the base frame, the lifting mechanism comprising:
two or more fluid cylinders each coupled to the seat assembly at one end and to the base frame at the other end;
a pump in fluid communication with the fluid cylinders for selectively extending and retracting the fluid cylinders;
an electric motor coupled to the pump for driving the pump, and
a power supply in electrical communication with the electric motor for powering the electric motor.

18. The manually propelled height-adjusting wheelchair of claim 17, further comprising a digital controller in communication with the electric motor for user control of the height adjustment mechanism.

19. The manually propelled height-adjusting wheelchair of claim 18, further comprising:
a gradient sensor in communication with the controller, the gradient sensor for determining a gradient of a surface on which the wheelchair is supported, wherein the controller limits elevation of the seat assembly if the gradient sensor determines that the wheelchair is on a predetermined unsafe gradient; and
a brake for braking one or more wheels of the manually propelled height-adjusting wheelchair, wherein the controller is configured to lock the brake when the seat assembly is in an elevated position.

20. A manually propelled height-adjusting wheelchair comprising a hydraulic height adjustment mechanism, and weighting at most about 37 pounds (17 kilograms).
